(19) United States
(12) Patent Application Publication
(10) Pub. No.: US 2012/0243000 A1
(43) Pub. Date: Sep. 27, 2012

(54) SHAPE MEASUREMENT METHOD AND SHAPE MEASUREMENT APPARATUS

(76) Inventors: Seiji Hamano, Hyogo (JP); Yusuke Kusaka, Osaka (JP); Fumio Sugata, Ehime (JP)

(21) Appl. No.: 13/512,974

(22) PCT Filed: May 31, 2011
(86) PCT No.: PCT/JP2011/003044

§ 371 Date: May 31, 2012

(30) Foreign Application Priority Data
Jun. 3, 2010 (JP) 2010-128052

(51) Int. Cl. G01B 11/02; G01B 9/02

(52) U.S. Cl. 356/496

(57) ABSTRACT

On each of an optical axis of light entering a measurement object and an optical axis of light entering a reference mirror, compound lens whose achromatic condition, beam diameter condition, and color difference reduction condition are optimized using the focal length and/or the Abbe number of a collimator lens are placed. By correcting the wavefront by using the compound lens, the effect of the wavefront aberration is reduced, and the resolution in the shape measurement based on the optical interferometry is increased.

### TECHNICAL FIELD

The present invention relates to a shape measurement method and a shape measurement apparatus which are based on optical interferometry with a high resolution.

### BACKGROUND ART

A shape measurement apparatus based on optical interferometry is shown in FIG. 6 (for example, see PATENT LITERATURE 1). Light emitted from a light source 601 through a lens 602 is split into reference light 606 and signal light 604 by a splitting means 603. The reference light 606 is reflected off a movable reference mirror 607. The signal light 604 enters a measurement object 605. As shown in FIG. 6, the movable reference mirror 607 mechanically shifts in the one-dimensional direction (the vertical direction in FIG. 6). Such shifting of the movable reference mirror 607 makes it possible to define the measurement position in the measurement object 605 in the optical axis direction of the signal light 604.

The signal light 604 enters the measurement object 605 via a light scanning optical system 600, and reflected off the measurement object 605. A specific example of the light scanning optical system 600 is an objective lens. The light scanning optical system 600 scans the signal light 604 entering the measurement object 605 in a prescribed direction. The reflected light from the movable reference mirror 607 and the reflected light from the measurement object 605 interfere with each other, to form interfering light. By detecting the interfering light with a detecting means 609 via a lens 608, information on the measurement object 605 is measured.

By the scanning in the axial direction of the incident light on the measurement object 605 from the movable reference mirror 607, the intensity data of the interfering light is successively acquired via a spectroscope 621 and an A/D converter 622. Then, based on the intensity data of the interfering light, a data arithmetical processing unit 623 made up of a PC (personal computer) structures a three dimensional image.

By scanning the signal light 604 entering the measurement object 605 in one direction in the plane of the measurement object 605, one-dimensional data can successively be acquired.

In this manner, using the images that can successively be obtained, a two dimensional image can be acquired by the data arithmetical processing unit 623. Further, by scanning the signal light 604 in two directions, a three dimensional image can be acquired by the data arithmetical processing unit 623.

In FIG. 6, instead of one-dimensionally and mechanically shifting the position of the measurement object 605, a light source that uses a certain wavelength width can be used.

FIG. 7 is a view showing the wavefront aberration with the conventional shape measurement apparatus. At the wavelengths of the light source λ=1200, 1300, 1400 nm, the image forming characteristic at the measurement depths ±3 mm is shown. With the conventional shape measurement apparatus, even when the actual aberration characteristic at the measurement depth center is a diameter of 50 μm, at the varying depth from the measurement depth center to +3 mm or −3 mm, the characteristic is degraded nearly to a diameter of 100 μm because of degradation of the wavefront aberration.

### CITATION LIST

### Patent Literature

PATENT LITERATURE 1: Japanese Unexamined Patent Publication No. 6-341809

### SUMMARY OF INVENTION

### Technical Problem

However, when the shape measurement based on the optical interferometry is performed by means of the conventional shape measurement apparatus shown in FIG. 6, there is such a problem that, when the resolution is increased, the wavefront is displaced.

An object of the present invention is to solve the problem stated above, and to provide a shape measurement method and a shape measurement apparatus that can increase the resolution without introducing any displacement of the wavefront in performing shape measurement based on the optical interferometry.

### Solution to Problem

In order to achieve the object stated above, the present invention is composed of as follows.

A shape measurement method of the present invention is characterized by comprising:

splitting light from a light source into reference light and signal light;

correcting a wavefront of the signal light by a first wavefront correction optical system that is placed on an optical axis of the signal light entering a measurement object, and thereafter, allowing the signal light to enter the measurement Object;

correcting a wavefront of the reference light by a second wavefront correction optical system that is placed on an optical axis of the reference light entering a reference mirror, and thereafter, allowing the reference light to enter the reference mirror; and

detecting interfering light of light being the reference light entering the reference mirror and being reflected off, and light being the signal light entering the measurement object and being reflected off, to measure a shape of the measurement object.

A shape measurement apparatus of the present invention is characterized by comprising:

a light source;

a beam splitter that splits light from the light source into reference light and signal light;

a processor device that detects interfering light of light being the reference light entering a reference mirror and being reflected off, and light being the signal light entering a measurement object and being reflected off, to measure a shape of the measurement object;

a first wavefront correction optical system that is placed on an optical axis of the signal light entering the measurement object, to correct a wavefront on the optical axis; and

a second wavefront correction optical system that is placed on an optical axis of the reference light entering the reference mirror, to correct a wavefront on the optical axis.

### Advantageous Effects of Invention

In accordance with the present invention, in the shape measurement based on the optical interferometry, with the measurement object-use wavefront correction optical system and the reference mirror-use wavefront correction optical system, the effect of the aberration of the wavefront can be reduced, and the resolution can be increased without introducing any displacement of the wavefront.

### BRIEF DESCRIPTION OF DRAWINGS

These and other aspects and features of the present invention will become clear from the following description taken in conjunction with the preferred embodiments thereof with reference to the accompanying drawings, in which:

FIG. 1 is a view showing a structure of a shape measurement apparatus according to a first embodiment of the present invention;

FIG. 2 is an enlarged view of a part of the structure of the shape measurement apparatus according to the first embodiment of the present invention;

FIG. 3 is an enlarged view of a part of a structure of a shape measurement apparatus according to a second embodiment of the present invention;

FIG. 4 is an enlarged view of a part of a structure of a shape measurement apparatus according to a third embodiment of the present invention;

FIG. 5 is a view showing a wavefront aberration in the shape measurement apparatus according to the first embodiment of the present invention;

FIG. 6 is a view showing a structure of a conventional shape measurement apparatus; and

FIG. 7 is a view showing a wavefront aberration of a conventional shape measurement apparatus.

### DESCRIPTION OF EMBODIMENTS

In the following, with reference to the drawings, a description will be given of embodiments of the present invention.

### First Embodiment

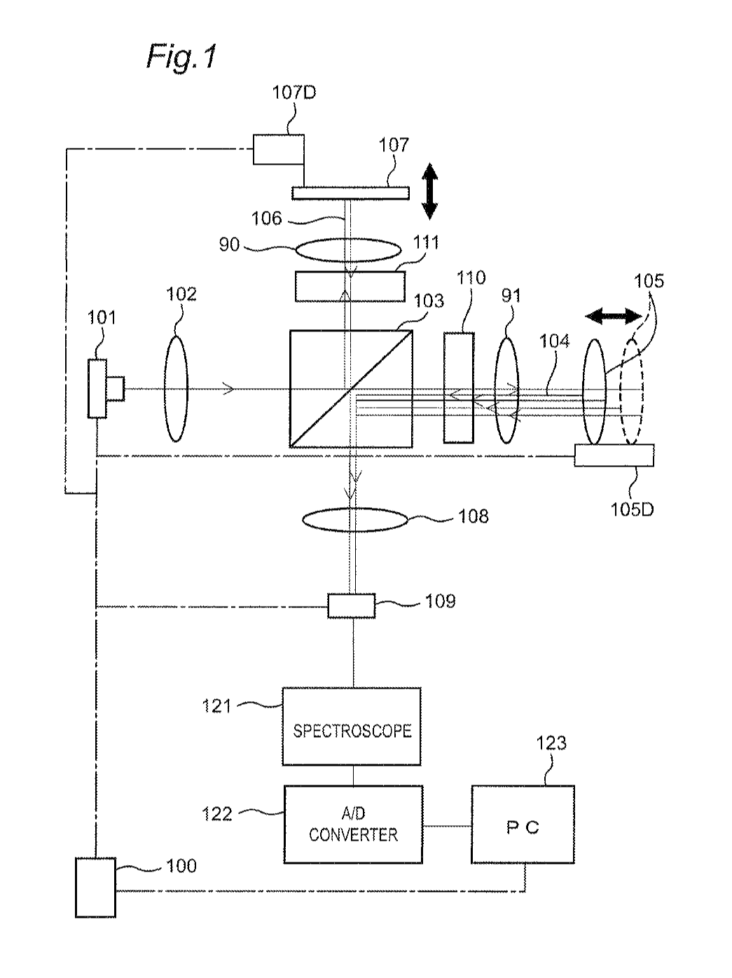

FIG. 1 is a view showing a structure of a shape measurement apparatus which can perform a shape measurement method according to a first embodiment of the present invention.

The shape measurement apparatus has: a light source 101; a lens 102; a beam splitter 103; a reference light aberration correction lens 111; a lens (optical system) 90; a movable reference mirror 107; an incident light aberration correction lens 110; an objective lens 91; a condenser lens 108; a detecting means 109; a spectroscope 121; an A/D converter 122; and a data arithmetical processing unit 123. The beam splitter 103 is one example of a splitting means or a splitter member. The data arithmetical processing unit 123 is composed of, e.g., a PC (personal computer) that functions as one example of a processor device. As the light source 101, a laser light source which emits light having a width of, e.g., wavelength λ=1200, 1300, 1400 nm is used.

The light emitted from the light source 101 radiates the beam splitter 103 via the lens 102. The light radiating the beam splitter 103 is spilt by the beam splitter 103 into reference light 106 and signal light 104. The reference light 106 passes through the reference light aberration correction lens 111, and thereafter, the reference light 106 is condensed by the lens 90, to arrive at the movable reference mirror 107. The reference light 106 arrived at the movable reference mirror 107 is reflected off the movable reference mirror 107 toward the beam splitter 103. Hence, the light has reflected off the movable reference mirror 107 returns to the beam splitter 103 via the lens 90 and the reference light aberration correction lens 111.

The movable reference mirror 107 is mechanically shifted by a movable reference mirror driver apparatus 107D in one-dimensional direction. By shifting the movable reference mirror 107, a measurement position in a measurement object 105 in the optical axis direction of the signal light 104 entering the measurement object 105 is defined. Examples of the measurement object 105 may include inside of the human body, the oral cavity, and the like, which are observed by an endoscope or an optical element such as a lens, an endoscope or the like. The reference light 106 is reflected off the beam splitter 103 and the movable reference mirror 107, and thereafter, detected by the detecting means 109 via the beam splitter 103. The movable reference mirror driver apparatus 107D may substantially be structured with, for example, a motor that is driven in forward and reverse rotation directions; a screw shaft fixed to the rotary shaft of the motor; a nut portion that is screwed with the screw shaft and that is coupled to the movable reference mirror 107; and a guide member that guides the movable reference mirror 107 in the optical axis direction so as to linearly advance and retract.

The signal light 104 passes through the incident light aberration correction lens 110, and thereafter, the signal light 104 is condensed by the objective lens 91, to enter the measurement object 105, and then the signal light 104 reflected off the measurement object 105. The signal light 104 reflected off the measurement object 105 passes through the incident light aberration correction lens 110 and the objective lens 91, and is reflected off the beam splitter 103, to be detected by the detecting means 109. The objective lens 91 scans the signal light 104 entering the measurement: object 105 in a prescribed direction.

The reflected light from the movable reference mirror 107 and the reflected light from the measurement object 105 interfere with each other at the beam splitter 103. And the resultant interfering light is condensed at the detecting means 109 through the condenser lens 108. The condensed interfering light is detected by the detecting means 109, and information on the measurement object 105 is measured. As the detecting means 109, a photodetector including indium gallium arsenide that has sensitivity at the wavelengths λ=1200, 1300, 1400 nm is used.

Based on the scanning in the axial direction of the incident light to the measurement object 105 from the movable reference mirror 107, the interfering light is dispersed and acquired by the spectroscope 121. Then, the acquired information on the interfering light is converted analog information to digital information by the A/D converter 122, and intensity data of the interfering light is successively acquired. Based on the successively acquired intensity data of the interfering light, a three dimensional image is structured with the data arithmetical processing unit 123.

By scanning the signal light 104 entering the measurement object 105 in one direction in the plane of the measurement object 105, one-dimensional data can successively be acquired. In order to scan in one direction, for example, a support member (not shown) that supports the measurement object 105 is shifted by a support member driver apparatus 105D in the optical axis direction of the measurement object 105. The support member driver apparatus 105D is similarly structured with the movable reference mirror driver apparatus 107D.

In this manner, using the images that can successively be acquired and performing arithmetical processing with the data arithmetical processing unit 123, a two dimensional image can be acquired. Further, using images that can be acquired by scanning the signal light 104 in two directions and performing arithmetical processing with the data arithmetical processing unit 123, a three dimensional image can be acquired.

In FIG. 1, instead of using the support member driver apparatus 1050 and one-dimensionally and mechanically shifting the position of the measurement object 105, a light source that uses a certain wavelength width can also be used.

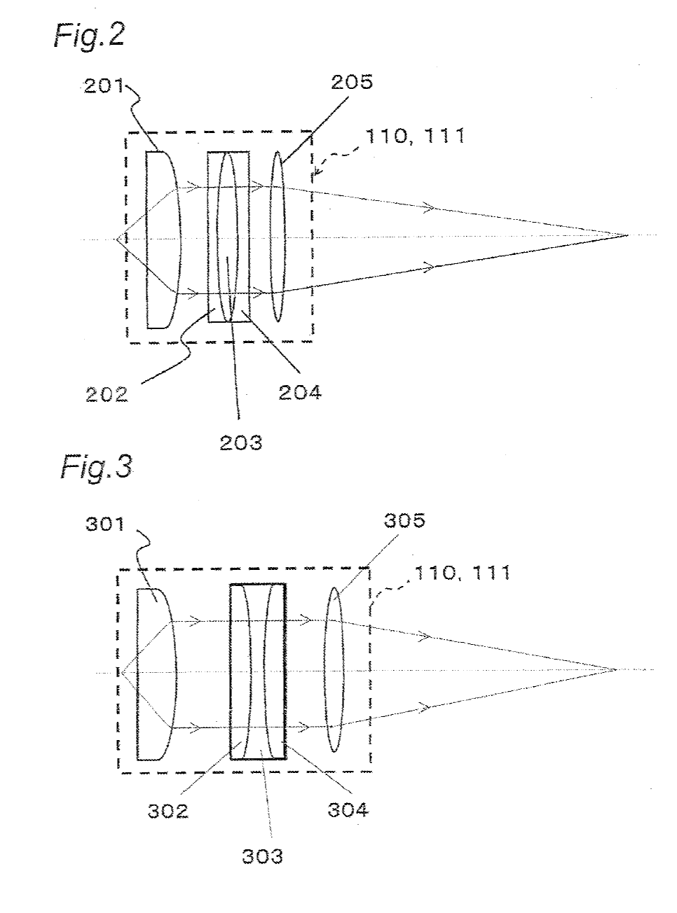

FIG. 2 shows details of the incident light aberration correction lens 110 and the reference light aberration correction lens 111 shown in FIG. 1. Since the incident light aberration correction lens 110 and the reference light aberration correction lens 111 are of the same structure, in FIG. 2 and the following FIGS. 3 and 1, they are collectively shown and described. The incident light aberration correction lens 110 functions as one example of the measurement object-use wavefront correction optical system being the first wavefront correction optical system. The reference light aberration correction lens 111 functions as one example of the reference mirror-use wavefront correction optical system being the second wavefront correction optical system. As shown in FIG. 2, the lens that corrects the wavefront (aberration correction lens) comprise a collimator lens 201, and a compound lens including three lenses 202, 203, and 204 as one example of a compound lens including a plurality of lenses, and an imaging lens 205. The lens that corrects the wavefront (aberration correction lens) structures each of the incident light aberration correction lens 110 and the reference light aberration correction lens 111. The three lenses 202, 203, and 204 of the compound lens are assembled in the following manner: the concave lens 202, the convex lens 203, and the concave lens 204 are aligned in order from the light input side to the light cutout side of the light source 101.

With reference to FIG. 1, in the following, description will be given of a working example 1 as a more specific example of the first embodiment.

The Abbe number of the collimator lens 201 is V_{dc}=50.3. The Abbe numbers of the three lenses 202, 203, and 204 of the compound lens are V_{d1}=35.3, V_{d2}=45.7, and V_{d3}=35.3, respectively.

The refractive index of the collimator lens 201 is n_{c}=1.605. The refractive indices of the three lenses 202, 203, and 204 of the compound lens are n₁=1.750, n₂=1.744, and n₃=1.750, respectively.

The focal length of the collimator lens 201 is f_{c}=15.52. The focal lengths of the three lenses 202, 203, and 204 of the compound lens are f₁=−8.08, f₂=4.35, and f₃=−8.08, respectively.

The achromatic condition X₁ with the structure of the working example 1 can be expressed by the following formula (Formula 1). The achromatic condition X₁ as used herein is a condition for reducing the aberration of the focal lengths of a plurality of wavelengths through a plurality of convex lenses and concave lenses.

X₁=1/f_{c}*V_{dc}+1/*f₁*V_{d1}+1/f₂*V_{d2}+1/f₃*V_{d3} (Formula 1)

As the value of the achromatic condition X₁ approaches zero, the wavefront aberration becomes smaller. That is, the more the following formula

(X₁=0) (Formula 1A)

is approximated, the wavefront aberration becomes smaller. The value of the achromatic condition X₁ obtained in the working example 1 is −0.0006. For the purpose of reducing the aberration of the focal lengths of a plurality of wavelengths, the value of the achromatic condition X₁ is desirably a value close to zero. Specifically, the value of the achromatic condition X₁ is desirably −0.05 or more and +0.05 or less.

The beam diameter condition X₂ with the structure of the working example 1 can be expressed by the following formula (Formula 2). The beam diameter condition X₂ as used herein is a condition for reducing the wavefront aberration through a plurality of convex lenses and the concave lenses.

X₂=1/f₁+1/f₂+1/f₃ (Formula 2)

As the value of the beam diameter condition X₂ approaches zero, the wavefront aberration becomes smaller. That is, the more the following formula

(X₂=0) (Formula 2A)

is approximated, the wavefront aberration becomes smaller. The value of the beam diameter condition X₂ obtained in the working example 1 is −0.018. For the purpose of reducing the wavefront aberration, the value of the beam diameter condition X₂ is desirably a value close to zero. Specifically, the value of the beam diameter condition X₂ is desirably −0.05 or more and +0.05 or less.

The color difference reduction condition X₃ with the structure of the working example 1 can be expressed by the following formula (Formula 3). The color difference reduction condition X₃ as used herein is a condition for reducing the color aberration of high-order of a plurality of wavelengths through a plurality of convex lenses and concave lenses.

X₃=|f_{c}/f₂| (Formula 3)

The color difference reduction condition X₃ is desirably 0 or more and 5 or less, such that the curvature of the lens correcting the wavefront (the incident light aberration correction lens 110 or the reference light aberration correction lens 111) does not become too large. The color difference reduction condition X₃ obtained in the working example 1 is 3.56. The reason why the color difference reduction condition X₃ is desirably 5 or less is that, when the color difference reduction condition X₃ exceeds 5, the wavefront aberration becomes great, and the resolution cannot be increased.

(X₃≦5) (Formula 3A)

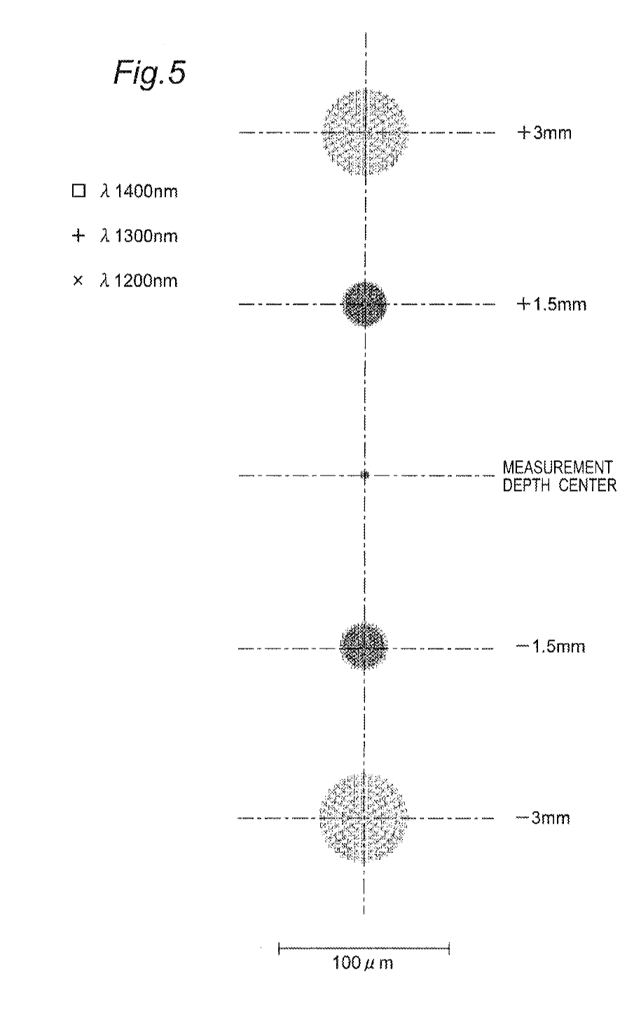

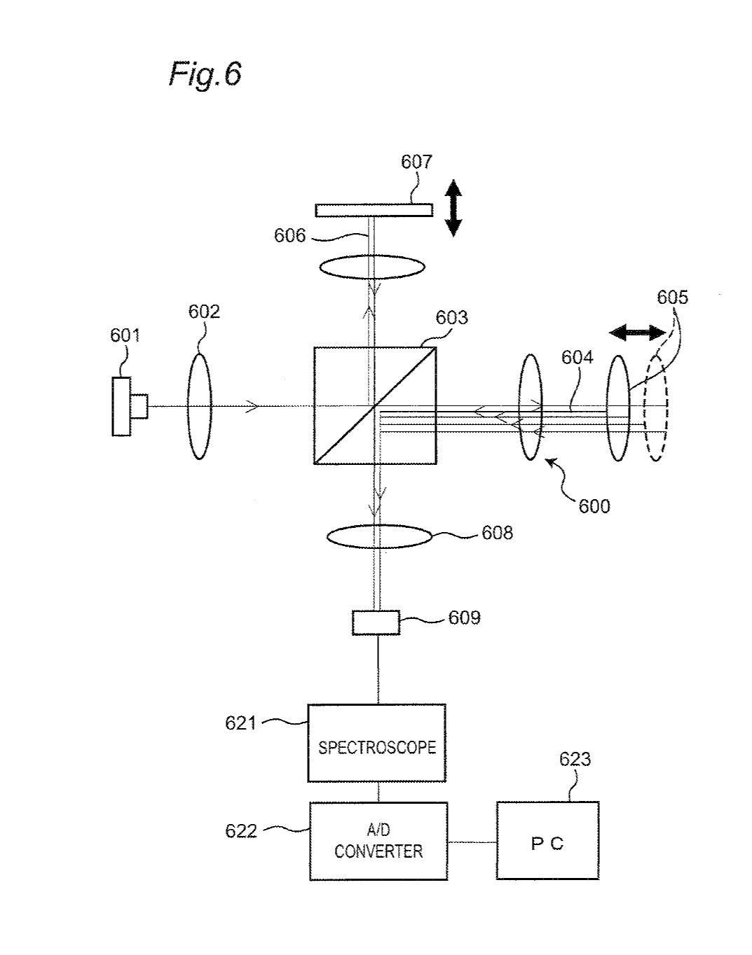

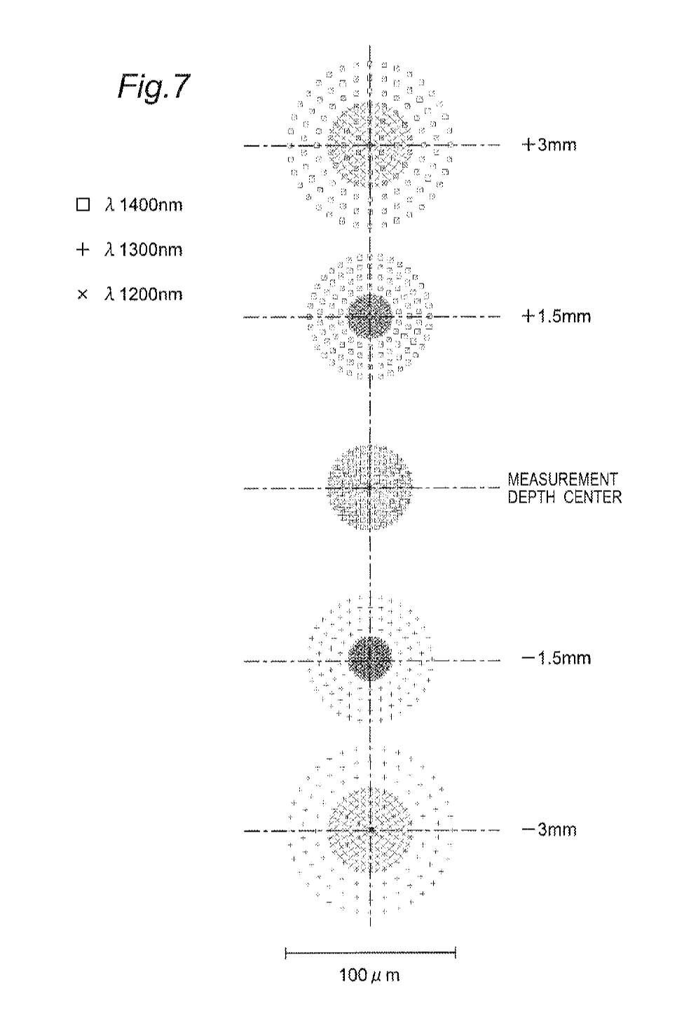

FIG. 5 is a view showing the wavefront aberration with the shape measurement apparatus according to the first embodiment of the present invention. FIG. 5 shows the imaging characteristic at measurement depths ±3 mm within a range of the wavelengths λ=1200, 1300, 1400 nm of the light source 101. With the shape measurement apparatus according to the first embodiment of the present invention, at the measurement depth center, the aberration characteristic has a diameter of 5 μm, and the wavefront aberration at the varying depth from the measurement depth center to +3 mm or −3 mm has a diameter of 50 μm. Hence, the wavefront aberration obtained by the shape measurement according to the first embodiment of the present invention shown in FIG. 5 exhibits the characteristic twice as excellent as the wavefront aberration with the conventional shape measurement shown in FIG. 7. That is, with the conventional shape measurement shown in FIG. 7, at the depth of +3 mm or −3 mm from the measurement depth center, the aberration characteristic is degraded to be approximately a diameter of 100 μl. However, in accordance with the first embodiment of the present invention, the wavefront aberration stops up to a diameter of 50 μm. Thus, the characteristic twice as excellent as the conventional shape measurement can be obtained. It is to be noted that, in the following second and third embodiments also, the result similar to FIG. 5 is obtained.

In the first embodiment, use of the incident light aberration correction lens 110 and the reference light aberration correction lens 111 realizes the shape measurement being free of the effect of the wavefront aberration. Here, the incident light aberration correction lens 110 and the reference light aberration correction lens 111 are each structured with one collimator lens 201, the compound lens including the three lenses 202, 203, and 204, and the imaging lens 205.

In other words, with the provision of the incident light aberration correction lens 110 and the reference light aberration correction lens 111 each including the compound lens including the three lenses 202, 203, and 204 whose achromatic condition, beam diameter condition, and color difference reduction condition are optimized, can reduce the effect of the wavefront aberration and correct the wavefront. Thus, the aberration correction optical systems (i.e., the incident light aberration correction lens 110 and the reference light aberration correction lens 111) each structured with the compound lens including the three lenses 202, 203, and 204 can increase the resolution without introducing any displacement of the wavefront.

More specifically any optical system whose incident light aberration correction lens 110 and reference light aberration correction lens 111 satisfy any one of (Formula 1A), (Formula 2A), and (Formula 3A) for the purpose of optimizing the achromatic condition, the beam diameter condition, and the color difference reduction condition can reduce the effect of the wavefront aberration. Further, satisfaction of a plurality of formulas out of (Formula 1A), (Formula 2A), and (Formula 3A) realizes the shape measurement with which the effect of the wavefront aberration is more surely reduced.

It is to be noted that, in a case where the shape measurement apparatus is automatically operated, a control apparatus 100 shown in FIG. 1 may be included. The control apparatus 100 controls the operation of the light source 101, the data arithmetical processing unit 123, the movable reference mirror driver apparatus 107D, the support member driver apparatus 105D, and the detecting means 109.

### Second Embodiment

FIG. 3 is a view showing a structure of an incident light aberration correction lens 110 and a reference light aberration correction lens 111 of a shape measurement apparatus according to a second embodiment of the present invention. In FIG. 1, the shape measurement apparatus according to the second embodiment of the present invention includes, instead of the structure of the compound lens being the combination of the convex lens (one collimator lens 201), the concave lens 202, the convex lens 203, and the concave lens 204 of the first embodiment shown in FIG. 2, a structure of a compound lens including lenses being a combination of a convex lens, a convex lens, a concave lens, and a convex lens shown in FIG. 3.

FIG. 3 is structured with a collimator lens 301 being a convex lens, and three lenses 302, 303, and 304 as one example of a compound lens including a plurality of lenses. The three lenses 302, 303, and 304 of the compound lens are assembled in the following manner: the convex lens 302, the concave lens 303, and the convex lens 304 are aligned in order from the light input side to the light output side of the light source 101.

With reference to FIG. 3, in the following, a description will be given of a working example 2 as more specific example of the second embodiment.

The Abbe number of the collimator lens 301 is V_{dc}=50.3. The Abbe numbers of the three lenses 302, 303, and 304 of the compound lens are V_{d1}=35.3, V_{d2}=45.7, and V_{d3}=35.3, respectively.

The refractive index of the collimator lens 301 is n_{c}=1.605. The refractive indices of the three lenses 302, 303, and 304 of the compound lens are n₁=1.750, n₂=1.744, and n₃=1.750, respectively.

The focal length of the collimator lens 301 is f_{c}=15.52. The focal length of the three lenses 302, 303, and 304 of the compound lens are f₁=8.08, f₂=3.97, and f₃=8.08, respectively.

The achromatic condition X₁ with the structure of the working example 2 can be expressed by the foregoing (Formula 1). As the value of the achromatic condition X₁ approaches zero, the wavefront aberration becomes smaller. That is, the value of the achromatic condition X₁ obtained in the working example 2 is −0.0031.

The beam diameter condition X₂ with the structure of the working example 2 can be expressed by the foregoing (Formula 2). As the value of the beam diameter condition X₂ approaches zero, the wavefront aberration becomes smaller. The value of the beam diameter condition X₂ obtained in the working example 2 is −0.0045.

The color difference reduction condition X₃ with the structure of the working example 2 can be expressed by the foregoing (Formula 3). The color difference reduction condition X₃ is desirably 5 or less, such that the curvature of the lens correcting the wavefront (the incident light aberration correction lens 110 or the reference light aberration correction lens 111) does not become too large. The color difference reduction condition X₃ obtained in the working example 2 is 3.91.

In the second embodiment, the incident light aberration correction lens 110 and the reference light aberration correction lens 111 each structured with the above-mentioned the collimator lens 301, the three lenses 302, 303, and 304 of the compound lens, and an imaging lens 305 are used. Use of the structure of the second embodiment realizes the shape measurement with which the effect of the wavefront aberration is reduced. In other words, in the second embodiment, in each of the incident light aberration correction lens 110 and the reference light aberration correction lens 111, the compound lens including the three lenses 302, 303, and 304 whose achromatic condition, beam diameter condition, and color difference reduction condition are optimized are used. With the aberration correction optical systems (i.e., the incident light aberration correction lens 110 and the reference light aberration correction lens 111) each structured with the three lenses 302, 303, and 304 of the compound lens, the effect of the wavefront aberration can be reduced, and the wavefront can be corrected. Thus, the resolution can be increased without introducing any displacement of the wavefront.

More specifically, any optical system whose incident light aberration correction lens 110 and reference light aberration correction lens 111 satisfy any one of (Formula 1A), (Formula 2A), and (Formula 3A) for the purpose of optimizing the achromatic condition, the beam diameter condition, and the color difference reduction condition can reduce the effect of the wavefront aberration. Further, satisfaction of a plurality of formulas out of (Formula 1A), (Formula 2A), and (Formula 3A) can more surely reduce the effect of the wavefront aberration.

### Third Embodiment

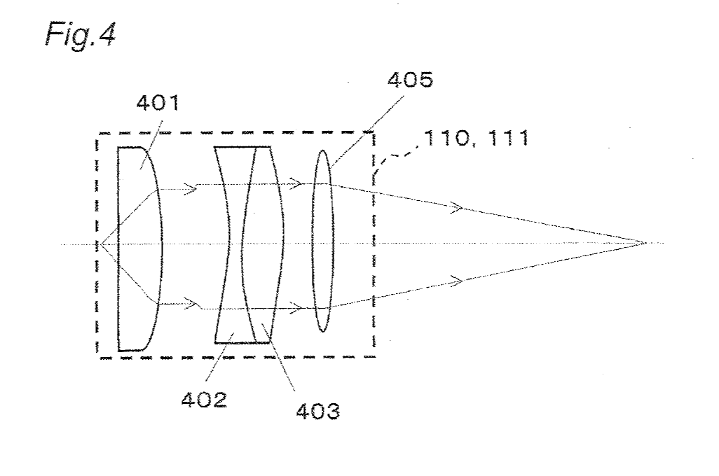

FIG. 4 is a view showing an incident light aberration correction lens 110 and a reference light aberration correction lens 111 according to a shape measurement apparatus according to a third embodiment of the present invention. The shape measurement apparatus according to the third embodiment of the present invention includes, instead of the structure of the compound lens having the combination of the convex lens 301, the convex lens 302, the concave lens 303, and the convex lens 304 of the second embodiment shown in FIG. 3, a structure of the compound lens having a combination of a convex lens, a concave lens, and a convex lens shown in FIG. 4.

FIG. 4 is structured with a collimator lens 401 being a convex lens, and two lenses 402 and 403 as one example of a compound lens including a plurality of lenses. The two lenses of the compound lens are assembled in the following manner: the concave lens 402 and the convex lens 403 are aligned in order from the light input side to the light output side of the light source 101.

With reference to FIG. 4, in the following, a description will be given of a working example 3 as more specific example of the third embodiment.

The Abbe number of the collimator lens 401 is V_{dc}=50.3. The Abbe numbers of the two lenses 402 and 403 of the compound lens are V_{d1}=18.9 and V_{d2}=32.3, respectively.

The refractive index of the collimator lens 401 is n_{c}=1.605. The refractive indices of the two lenses 402 and 403 of the compound lens are n₁=1.923 and n₂=1.850, respectively. The focal length of the collimator lens 401 is f_{c}=15.52. The focal lengths of the two lenses 402 and 403 of the compound lens are f₁=8.77 and f₂=9.56, respectively.

The achromatic condition X₁ with the structure of the working example 3 can be expressed by the foregoing (Formula 1). As the value of the achromatic condition X₁ approaches zero, the wavefront aberration becomes smaller. That is, the value of the achromatic condition X₁ in the working example 3 is −0.0015.

The beam diameter condition X₂ with the structure of the working example 3 can be expressed by the foregoing (Formula 2). As the value of the beam diameter condition X₂ approaches zero, the wavefront aberration becomes The value of the beam diameter condition X₂ obtained in the working example 3 is −0.004.

The color difference reduction condition X₃ with the structure of the working example 3 can be expressed by the foregoing (Formula 3). The color difference reduction condition X₃ is desirably 5 or less, such that the curvature of the lens correcting the wavefront (the incident light aberration correction lens 110 or the reference light aberration correction lens 111) does not become too large. The color difference reduction condition X₃ obtained in the working example 3 is 1.77.

In the third embodiment, the incident light aberration correction lens 110 and the reference light aberration correction lens 111 each structured with the above-described the collimator lens 401, the two lenses 402 and 403 of the compound lens, and an imaging lens 405 are used. Use of the structure of the third embodiment realizes the shape measurement with which the effect of the wavefront aberration is reduced. In other words, in the third embodiment, in each of the incident light aberration correction lens 110 and the reference light aberration correction lens 111, the compound lens including the two lenses 402 and 403 whose achromatic condition, beam diameter condition, and color difference reduction condition are optimized are used. With the aberration correction optical systems (i.e., the incident light aberration correction lens 110 and the reference light aberration correction lens 111) each structured with the two lenses 402 and 403 of the compound lens, the effect of the wavefront aberration can be reduced, and the wavefront can be corrected. Thus, the resolution can be increased without introducing any displacement of the wavefront.

More specifically, any optical system whose incident light aberration correction lens 110 and reference light aberration correction lens 111 satisfy any one of (Formula 1A), (Formula 2A), and (Formula 3A) for the purpose of optimizing the achromatic condition, the beam diameter condition, and the color difference reduction condition can reduce the effect of the wavefront aberration. Further, satisfaction of a plurality of formulas out of (Formula 1A), (Formula 2A), and (Formula 3A) can more surely reduce the effect of the wavefront aberration.

Further, in the third embodiment, the compound lens including the two lenses 402 and 403 are structured with lenses smaller in number than the shape measurement apparatus according to the first embodiment and the shape measurement apparatus according to the second embodiment. Hence, with the shape measurement apparatus according to the third embodiment, the material costs when being practiced becomes more inexpensive, and the structure thereof can further be simplified.

By properly combining the arbitrary embodiments of the aforementioned various embodiments, the effects possessed by the embodiments can be produced.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

### INDUSTRIAL APPLICABILITY

The shape measurement method and the shape measurement apparatus according to the present invention are a shape measurement method and a shape measurement apparatus that can increase the resolution without introducing displacement of the wavefront, and that are based on optical interferometry with a high resolution. Therefore, they are applicable to industrial process quality control, various modes of measurement, or test apparatuses. Further, the present invention can also be used for vital observation, i.e., as an endoscope or the like.

1-10. (canceled)

11. A shape measurement apparatus, comprising:
a light source;
a beam splitter that splits a light from the light source into a reference light and a signal light;
a processor device that detects an interfering light of a light being the reference light entering and reflected off a reference mirror, and a light being the signal light entering and reflected off a measurement object, to measure a shape of the measurement object;
a first wavefront correction optical system that is placed on an optical axis of the signal light entering the measurement object, to correct a wavefront on the optical axis of the signal light; and
a second wavefront correction optical system that is placed on an optical axis of the reference light entering the reference mirror, to correct a wavefront on the optical axis of the reference light,
wherein the first wavefront correction optical system or the second wavefront correction optical system comprises a collimator lens, a compound lens including three lenses, and an imaging lens, and
wherein when it is defined that: an Abbe number of the collimator lens is V_{dc}; Abbe numbers of the three lenses of the compound lens are V_{d1}, V_{d2}, and V_{d3}; a focal length of the collimator lens is f_{c}; and focal lengths of the three lenses of the compound lens are f₁, f₂, and f₃,
a value X₁ obtained from (Formula 1) being an achromatic condition is −0.05 or more and +0.05 or less, wherein
X₁=1/f_{c}*V_{dc}+1/f₁*V_{d1}+1/f₂*V_{d2}+1/f₃*V_{d3} (Formula 1).

12. The shape measurement apparatus according to claim 11, wherein when it is defined that: the focal length of the collimator lens is f_{c}; and the focal lengths of the three lenses of the compound lens are f₁, f₂, and f₃,
a value X₂ obtained from (Formula 2) being a beam diameter condition is −0.05 or more and +0.05 or less, wherein
X₂=1/f₁+1/f₂+1/f₃ (Formula 2).

13. A shape measurement apparatus, comprising:
a light source;
a beam splitter that splits a light from the light source into a reference light and a signal light;
a processor device that detects an interfering light of a light being the reference light entering and reflected off a reference mirror, and a light being the signal light entering and reflected off a measurement object, to measure a shape of the measurement object;
a first wavefront correction optical system that is placed on an optical axis of the signal light entering the measurement object, to correct a wavefront on the optical axis of the signal light; and
a second wavefront correction optical system that is placed on an optical axis of the reference light entering the reference mirror, to correct a wavefront on the optical axis of the reference light,
wherein the first wavefront correction optical system or the second wavefront correction optical system comprises a collimator lens, a compound lens including three lenses, and an imaging lens, and
wherein when it is defined that: a focal length of the collimator lens is f_{c}; and focal lengths of the three lenses of the compound lens are f₁, f₂, and f₃,
a value X₂ obtained from (Formula 2) being a beam diameter condition is −0.05 or more and +0.05 or less, wherein
X₂=1/f₁+1/f₂+1/f₃ (Formula 2).

14. The shape measurement apparatus according to claim 11, wherein when it is defined that: the focal length of the collimator lens is f_{c}; and the focal lengths of the three lenses of the compound lens are f₁, f₂, and f₃,
a value X₃ obtained from (Formula 3) being a color difference reduction condition is 0 or more and 5 or less, wherein
X₃=|f/f₂| (Formula 3).

15. A shape measurement apparatus, comprising:
a light source;
a beam splitter that splits a light from the light source into a reference light and a signal light;
a processor device that detects an interfering light of a light being the reference light entering reflected off a reference mirror, and a light being the signal light entering and reflected off a measurement object, to measure a shape of the measurement object;
a first wavefront correction optical system that is placed on an optical axis of the signal light entering the measurement object, to correct a wavefront on the optical axis of the signal light; and
a second wavefront correction optical system that is placed on an optical axis of the reference light entering the reference mirror, to correct a wavefront on the optical axis of the reference light,
wherein the first wavefront correction optical system or the second wavefront correction optical system comprises a collimator lens, a compound lens including three lenses, and an imaging lens, and
wherein when it is defined that: a focal length of the collimator lens is f_{c}; and focal lengths of the three lenses of the compound lens are f₁, f₂, and f₃,
a value X₃ obtained from (Formula 3) being a color difference reduction condition is 0 or more and 5 or less, wherein
X₃=|f_{c}/f₂| (Formula 3).

16. The shape measurement apparatus according to claim 11, wherein the three lenses of the compound lens are a combination of a concave lens, a convex lens, and a concave lens aligned in order.

17. The shape measurement apparatus according to claim 11, wherein the three lenses of the compound lens are a combination of a convex lens, a concave lens, and a convex lens aligned in order.
